(19) United States
(12) Patent Application Publication
(10) Pub. No.: US 2012/0180959 A1
(43) Pub. Date: Jul. 19, 2012

(54) Aperture Closure Arrangements

(76) Inventor: Bruce Stanley Gunton, Yoxall (GB)

(21) Appl. No.: 13/005,986

(22) Filed: Jan. 13, 2011

(51) Int. Cl. E06B 3/52; E06B 3/44

(52) U.S. Cl. 160/188

(57) ABSTRACT

An aperture closure arrangement 10a has an aperture closure 12a formed from a plurality of panels 39 hinged together at generally horizontal axes. Each panel 39 has a runner 16a fixed near its upper edge and constrained to run in a track 31. The track 31a, 31b, 31c defines the path of the runners 16a, as the aperture closure 12a opens and closes, and therefore defines the movement of the panels 39. An elongate flexible member 22a in the form of a cable or chain is connected to the aperture closure 12a at an attachment point 24a. The elongate flexible member 22a is also connected to a drive arrangement (not shown) operable to pull open the aperture closure 12a. Guide members 30, 32 define the path of the elongate flexible member 22a between the attachment point 24a and the drive arrangement (not shown). At least one of the guide members 30 is a deflection member sufficiently close to the track 31c to allow the attachment point 24a to pass the deflection member 30 beyond the deflection member 30 when viewed from the said path, as the aperture closure 12a closes and opens, thereby threading and unthreading the elongate flexible member 22a from the deflection member 30.

The present invention relates to improvements in or relating to aperture closure arrangements.

In many conventional installations, for example domestic doors for garages or the like, a powered door is moved to the top of the aperture when open. This is found to restrict headroom in the aperture, with adverse consequences for safety and aesthetics.

Examples of the invention provide apparatus comprising:
an aperture closure formed from a plurality of panels hinged together at generally horizontal axes;
at least one runner member attached to a vertical edge of the door;
a track defining the path of the or each runner member as the aperture closure opens and closes;
an elongate flexible member connected to the door at an attachment point and to a drive arrangement to allow the drive arrangement to pull the door open;
and at least one guide member to define the path of the elongate flexible member between the attachment point and the drive arrangement and which is a deflection member sufficiently close to the track to allow the attachment point to pass the or each deflection member beyond the deflection member when viewed from the said path, as the door closes and opens, thereby threading and unthreading the elongate flexible member from the or each deflection member.

There may be a plurality of guide members, at least some of which are deflection members from which the elongate flexible member threads and unthreads as aforesaid. All of the guide members may be deflection members as aforesaid.

The guide member or members may be pulleys. The or one of the deflection members may be the guide member closest to the attachment point, when the door is fully closed.

There may be a guide member which acts as a limit member and is spaced sufficiently from the track to prevent the attachment point passing to the other side of the limit member than the track, thereby providing an open limit of movement for the aperture closure.

The track may comprise a generally upright section and a further section for receiving the door, when open. The further section may be generally horizontal. A transition section may be provided, defining a curved leg of the path, between the upright section and the further section. The or one of the deflection members may be located above the upright section. There may be a plurality of deflection members positioned to guide the elongate flexible member around the transition section and from which the elongate flexible member is able to unthread as the door opens, to allow the door to move wholly on to the further section. Alternatively, the attachment point may reach a limit member after leaving the upright section. There may be at least one guide member associated with the further section to cause the elongate flexible member to pull along the further section, during use.

The track may be located alongside the edge of the door. Tracks may be provided alongside both edges of the door.

Example embodiments of the present invention can now be described in more detail, by reference to the accompanying drawings, in which:

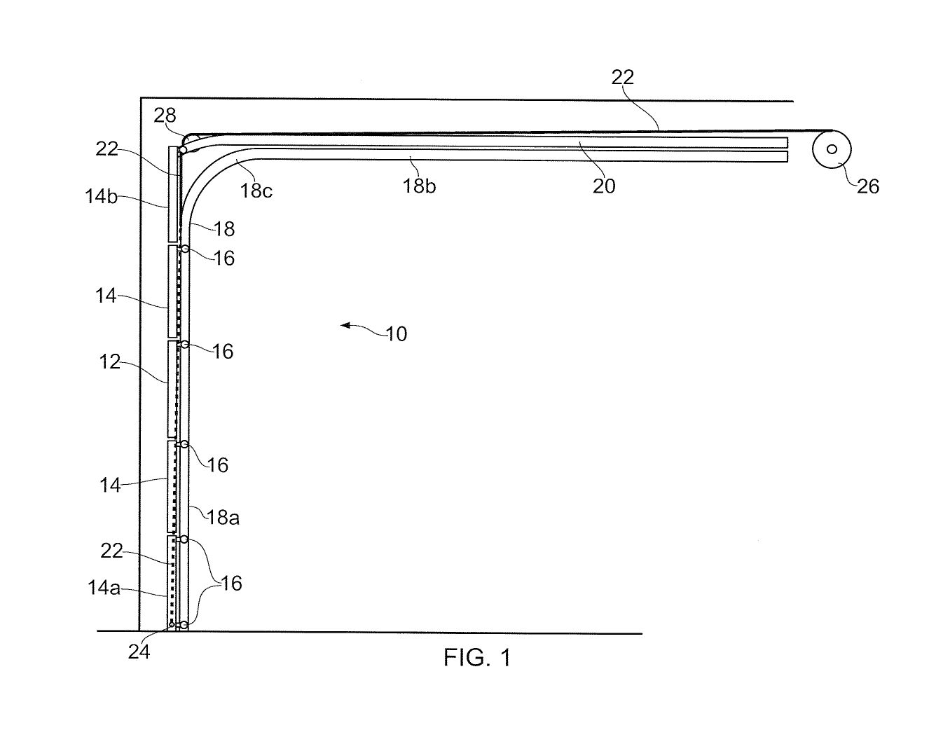

FIG. 1 is a side elevation of an aperture closure and associated apparatus, shown in the fully closed position;

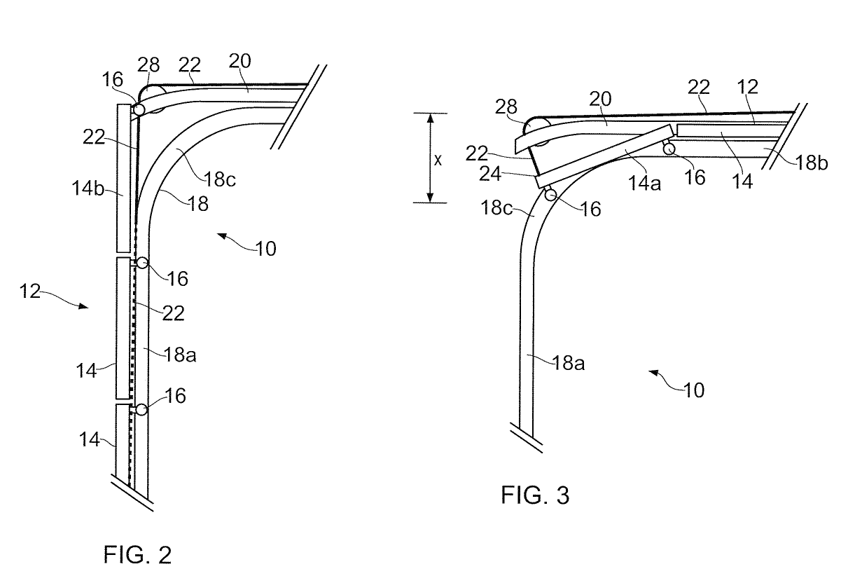

FIG. 2 is an enlarged partial view, corresponding with FIG. 1;

FIG. 3 corresponds with FIG. 2, showing the fully open position;

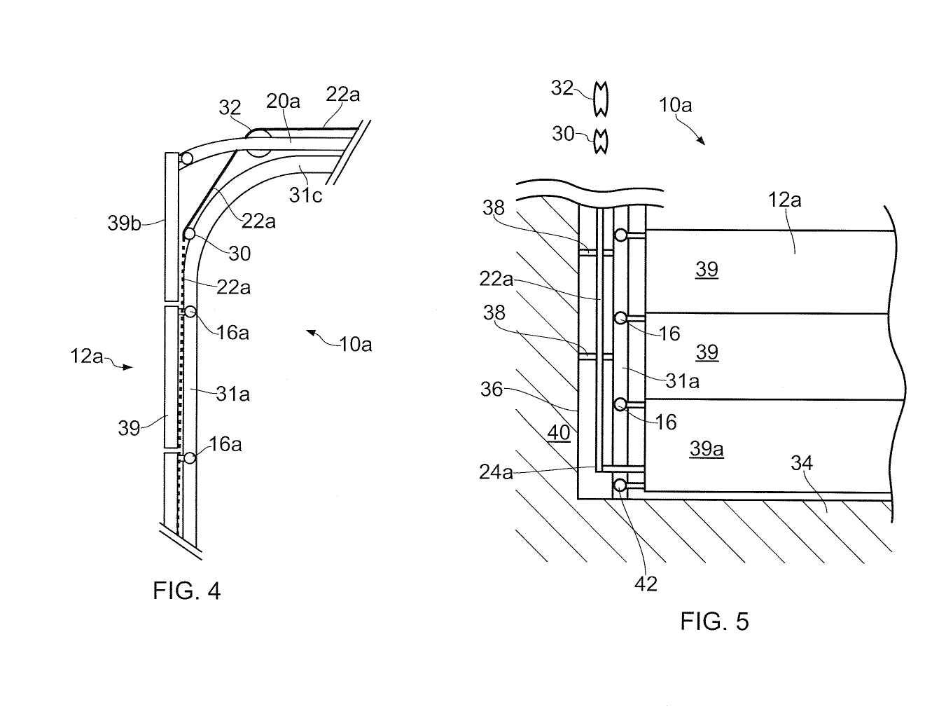

FIG. 4 is an enlarged partial side elevation of an aperture closure and associated apparatus in accordance with one example of the invention, shown in the fully closed position;

FIG. 5 is a partial front elevation, corresponding with FIG. 4;

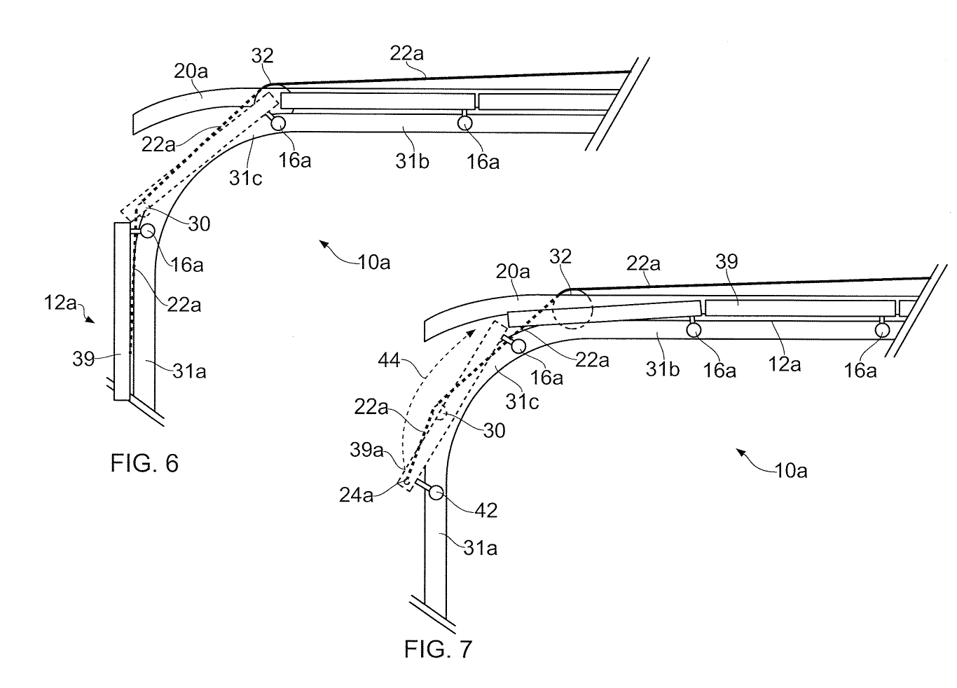

FIGS. 6 to 9 correspond with FIG. 4, illustrating various stages of movement of the aperture closure toward the fully open position;

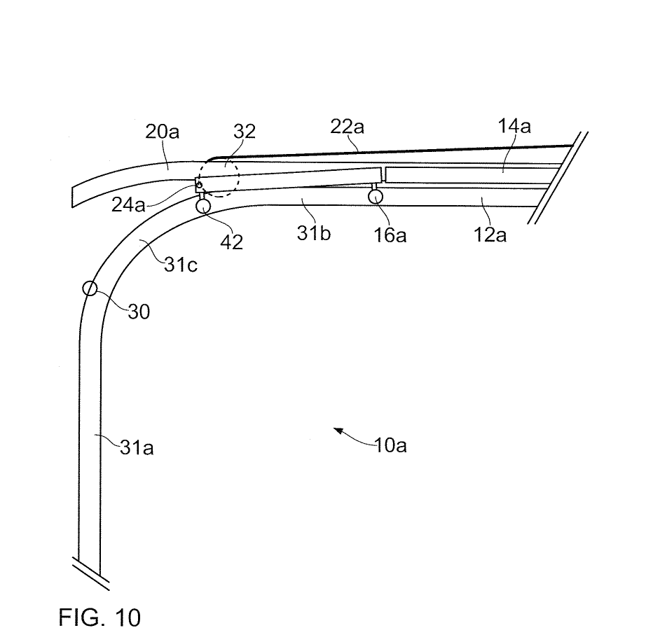

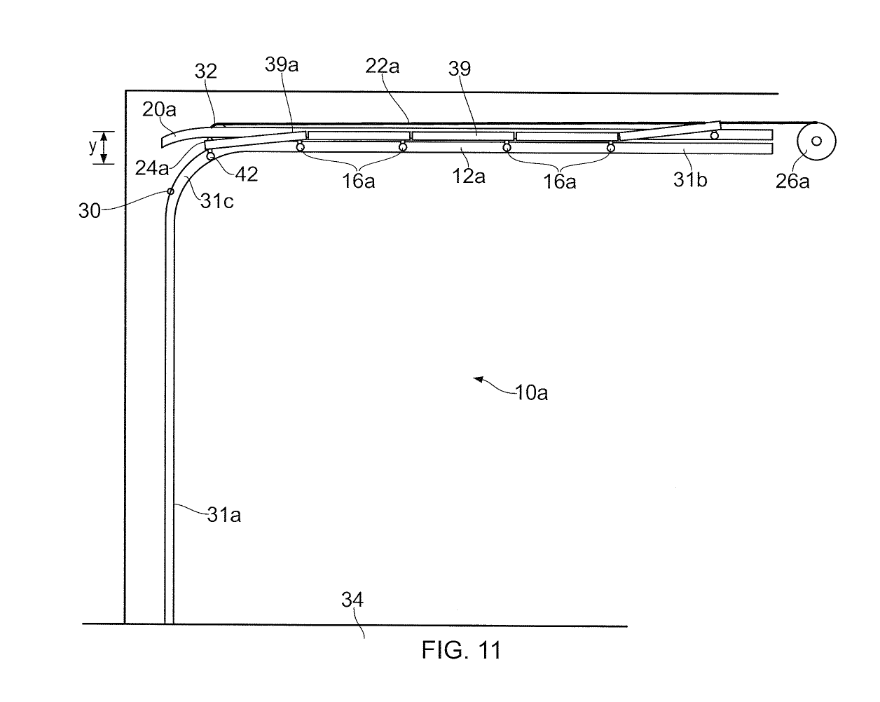

FIGS. 10 and 11 show the fully open position of the apparatus of FIGS. 4 to 9;

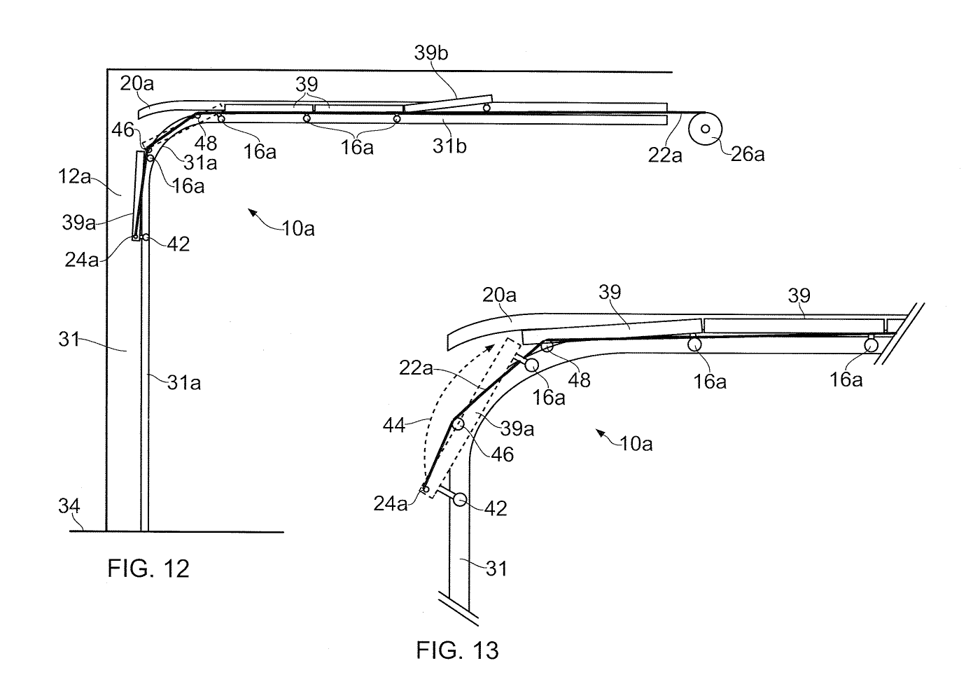

FIGS. 12, 13, 14, and 15 generally correspond with FIGS. 6, 7, 8 and 9, illustrating another example of the invention;

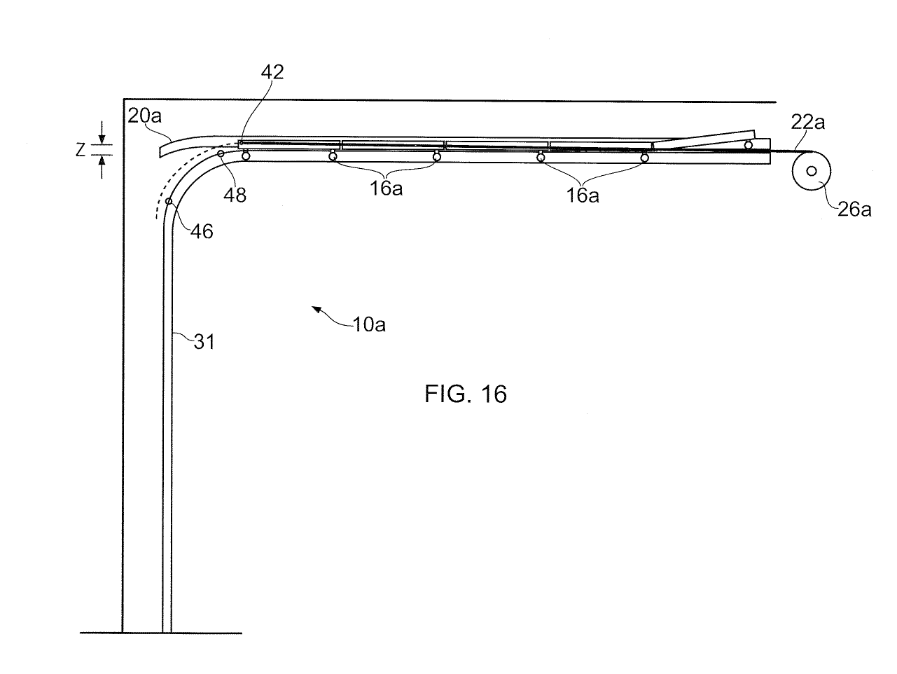

FIG. 16 illustrates the fully open position of the second example of the invention, and

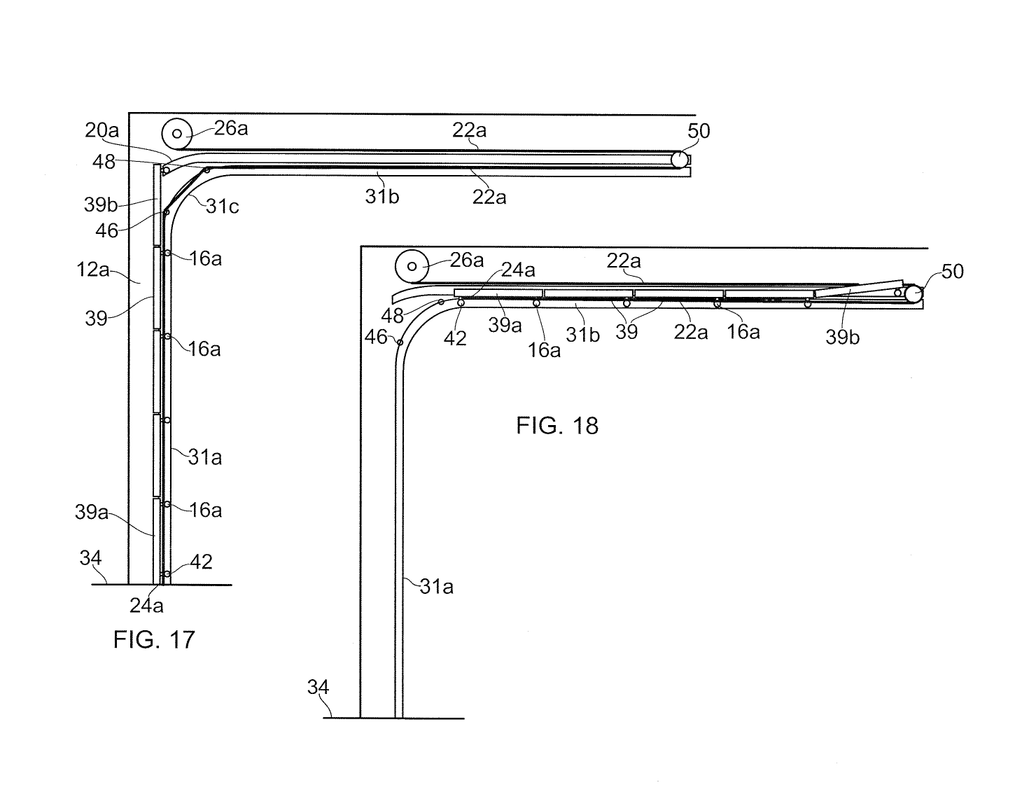

FIGS. 17 and 18 show a further example, respectively in the closed and fully open positions.

FIG. 1 illustrates apparatus 10 comprising an aperture closure or door 12 formed from a plurality of panels 14. The panels 14 are long planks reaching horizontally across the aperture being closed, and hinged to neighbouring panels 14, at their upper and lower edges, to form an articulated door or shutter. Each panel 14 has a runner 16 fixed near its upper edge and constrained to run in a track 18. The track 18 defines the path of the runners 16, as the door 12 opens and closes, and therefore defines the movement of the panels 14.

The lowermost panel 14a has a second runner 16 near its lower edge and also constrained in the track 18.

The runner 16 of the uppermost panel 14b is constrained in a second track 20.

The track 18 has a generally vertical leg 18a, a generally horizontal leg 18b and a transition section 18c which defines a curved leg between the upright section 18a and the horizontal section 18b. The track 20 is generally horizontal, positioned slightly above the track 18, but curves downward slightly, above the transition section 18c.

An elongate flexible member 22 in the form of a cable or chain is connected to the door 12 at an attachment point 24, near the bottom edge of the lowermost panel 14a. The cable 22 is also connected to a drive arrangement 26 in the form of a powered cable drum. The cable 22 extends around a guide pulley 28 in the region of the downward curve of the track 20, generally above the upright leg 18a of the track 18. The guide pulley 28 defines the path of the cable 22 between the attachment point 24 and the cable drum 26. This allows the cable drum 26 to be turned to pull the cable 22, thereby pulling open the door 12.

This movement can be seen more clearly in FIGS. 2 and 3. In FIG. 2, the door 12 is in the fully closed position. The location of the cable 22 around the guide pulley 28 means that when the cable drum 26 pulls the cable 22, the cable 22 in turn provides a generally vertical pull from the guide pulley 28 to the attachment point 24, causing the panels 14 to rise, and causing the runners 16 to run up the vertical section 18a of the track 18. This also pushes the uppermost runner along the upper track 20. As the cable 22 continues to pull up the attachment point 24, the panels 14, one by one leave the vertical section of the track 18, move around the transition section 18c. and on to the horizontal section 18b.

Eventually the position of FIG. 3 is reached. At this position, the attachment point 24 is close to the guide pulley 28. The line of the cable 22, from the attachment point 24 to the guide pulley 28 is now substantially perpendicular to the track 18. Consequently, no further opening movement can be achieved by pulling on the cable 22 and the position reached at FIG. 3 represents the open limit of the door 12.

When fully open, as shown in FIG. 3, the arrangement has a depth x represented by the spacing of the attachment point 24 below the upper extremity of the pulley 28. This depth may represent a significant disadvantage for this arrangement, when installed in a closure for which limited headroom is available. Limited headroom is a constraint in many domestic situations, such as with domestic garage doors. This constraint may adversely affect safety by increasing the risk of head injuries. Aesthetics may also be adversely affected.

The following drawings illustrate an example of an improved arrangement in which the depth of the door, when fully open, is reduced from that shown in FIG. 3.

Many features illustrated in FIGS. 4 to 11 correspond with features illustrated in FIGS. 1 to 3 and are therefore given the same reference numerals, with the suffix “a”. Reference should be made to the above description, for a fuller understanding of these features.

The most significant difference between the arrangement of FIG. 4 and the previous drawings can be seen in the region of the transition section of the track. The track is numbered 31 and has a vertical leg 31a, a horizontal leg 31b and a transition section 31c. The guide pulley 28 is no longer present, near the end of the track 20a. Instead, guide members 30 and 32 are provided. The guide members 30, 32 define the path of the cable 22a, but the path differs from that described above.

The guide member 30 is a deflection member which is a pulley of relatively small diameter. The guide member 32 is a limit member, which is a pulley of relatively large diameter. The deflection member 30 is positioned close to the top of the vertical section 31a of the track 31 and is therefore closer to the attachment point 24a, when the door 12a is fully closed, than the limit pulley 32.

The deflection pulley 30 is close to the track 31, when viewed transverse to the track, as in FIG. 4. The deflection pulley 30 is spaced sufficiently closely to the track 31 to allow the attachment point 24a to pass the deflection pulley beyond the deflection pulley 30 when viewed from the track 31, as the door closes and opens, as will be illustrated in more detail in later drawings. This allows the cable 22a to thread and unthread from the deflection pulley 30.

Turning to FIG. 5, there is shown a front elevation with the door 12a in the fully closed position, near the ground 34. The track 18 is installed at the edge of the aperture 36 to be closed by the door 12a, by means of supporting brackets 38. The door 12a consists of panels 39, like the panels 14, with a lowermost panel 39a and an uppermost panel 39b. The runners 16a extend from the respective panels 39 to the track 31, where they are captive. The attachment point 24 extends beyond the track 31, to be fixed to the end of the cable 22a. Thus, when viewed perpendicular to the plane of the closed door 12a, the cable 22a runs in a plane which lies between the track 31 and the wall 40 to which the track 31 is mounted. The deflection pulley 30 and the limit pulley 32 also lie in this plane, as illustrated schematically at the top of FIG. 5.

When the door is opening, the cable drum 26a turns to pull the cable 22a. This results in a generally vertical pull on the attachment point 24a, along the line from the deflection pulley 30 to the attachment point 24a. Consequently, as the door 12a opens, panels 39 move one after the other from the upright section 31a of the track 31 on to the horizontal section 31b of the track 31, as cable 22a is pulled past the deflection pulley 30 and limit pulley 32. An intermediate stage of this process is illustrated in FIG. 6. Some panels 39 have moved on to the horizontal leg 31b of the track 31. Another panel 39 is shown still on the vertical leg 31a of the track 31. A further panel 39 is shown passing around the transition section 31c of the track 31.

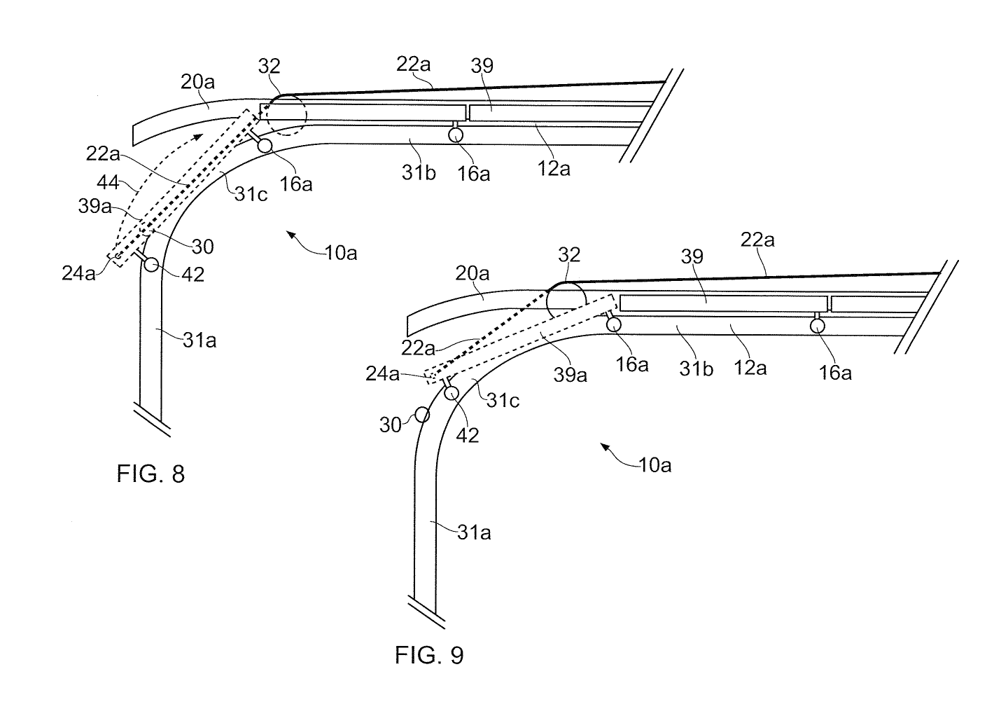

In due course, the lowermost panel 39a reaches the top of the track 31a. As the cable 22a continues to be pulled, the attachment point 24a reaches the deflection pulley 30. The lowermost runner 42 remains in the track 31. The deflection pulley 30 is sufficiently close to the track 31 to allow the attachment point 24a to pass outside the deflection pulley 30. That is, the attachment point 24 passes the deflection pulley beyond the deflection pulley 30, as viewed from the track 31. This passage of the attachment point 24a outside the deflection pulley 30 is illustrated in an exaggerated manner in FIGS. 7 and 8 by arrows 44. Consequently, when the door 12a is opening, the passage of the attachment point 24a unthreads the cable 22a from around the deflection pulley 30. The direction of pull on the attachment point 24a is now defined by the relative positions of the attachment point 24a and limit pulley 32, as can be seen from FIG. 9. Accordingly, the door 12a can be pulled further open. Eventually, the position of FIG. 10 is reached in which the attachment point 24a is close to the limit pulley 32, the direction of pull on the attachment point 24 is perpendicular to the track 31, and further movement of the door 12a is not possible.

It can be seen from FIG. 10 and from FIG. 11 that when the open limit is reached, as just described, the panels 39 are all lying substantially horizontally along the horizontal leg 31b of the track 31. In particular, the fully open door 12a has a depth y which is less than the depth x of the arrangement of FIG. 3, as can be seen by a comparison of FIGS. 3 and 10.

When the door is to be closed, the cable drum 26 is turned in the opposite direction to pay out cable 22a, allowing the door panels 39 to move back down the track 31 to the fully closed position (FIG. 4). This movement may be assisted by a spring which is compressed as the door reaches the fully open position, and pushes back when the cable is released, to start the movement of the door. As the attachment point 24a reaches the deflection pulley 30, the attachment point 24a passes the pulley 30 beyond the pulley 30, as viewed from the track 31, so that the cable 22a is threaded back onto the deflection pulley 30.

The second example of the invention is illustrated in FIGS. 12 to 16. Many features illustrated in FIGS. 12 to 16 correspond with features illustrated in FIGS. 4 to 11 and are therefore given the same reference numerals. Reference should be made to the above description, for a fuller understanding of these features.

The most significant difference between the arrangement of FIGS. 12 to 16 and the previous drawings can be seen in the region of the transition section of the track. The track is again numbered 31 and has a vertical leg 31a, a horizontal leg 31b and a transition section 31c. The guide members 30 and 32 are no longer present, near the end of the track 20a. Instead, guide members 46 and 48 are provided. The guide members 46, 48 define the path of the cable 22a, but the path differs from that described above.

The guide members 46, 48 are deflection members which are pulleys of relatively small diameter. The deflection member 46 is positioned close to the top of the vertical section 31a of the track 31 and is therefore closer to the attachment point 24a, when the door 12a is fully closed, than the deflection member 48. The deflection member 48 is nearer the front end of the horizontal section 31b of the track 31. Thus, the deflection members 46, 48 together guide the cable 22a around the transition section 31c of the track 31.

The deflection pulleys 46, 48 are close to the track 31, when viewed transverse to the track, as in FIG. 13. The deflection pulleys 46, 48 are spaced sufficiently closely to the track 31 to allow the attachment point 24a to pass the deflection pulleys beyond the deflection pulleys 46, 48 when viewed from the track 31, as the door closes and opens, as will be illustrated in more detail in later drawings. This allows the cable 22a to thread and unthread from the deflection pulleys 46, 48.

When the door is opening, the cable drum 26a turns to pull the cable 22a. This results in a generally vertical pull on the attachment point 24a, along the line from the deflection pulley 46 to the attachment point 24a. Consequently, as the door 12a opens, panels 39 move one after the other from the upright section 31a of the track 31 on to the horizontal section 31b of the track 31, as cable 22a is pulled past the deflection pulleys 46, 48. Intermediate stages of this process are illustrated in FIGS. 13, 14 and 15. Some panels 39 have moved on to the horizontal leg 31b of the track 31.

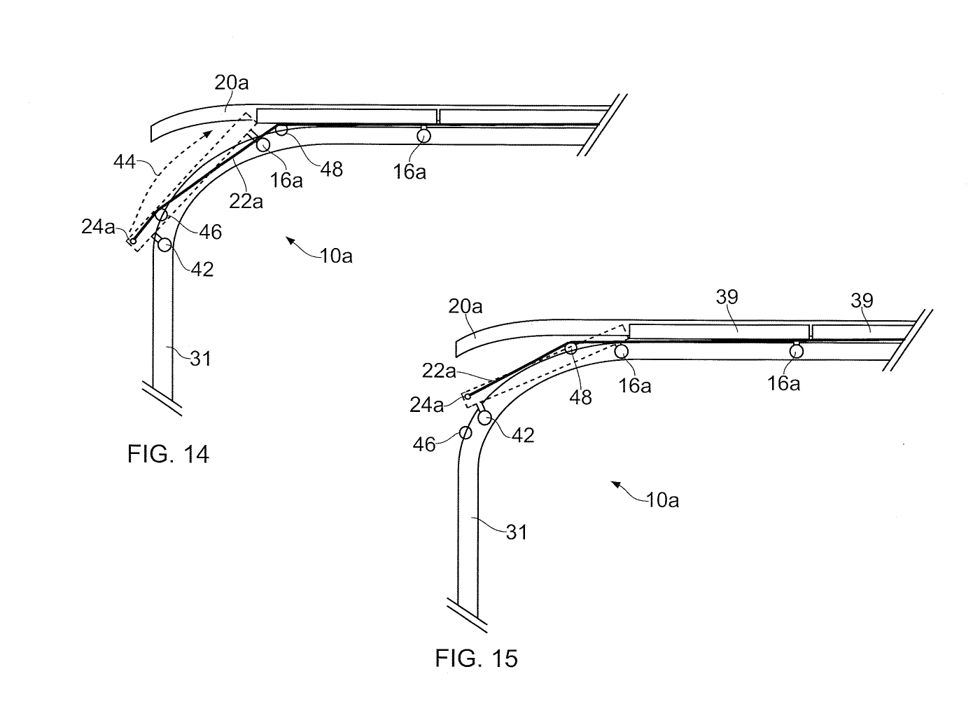

In due course, the lowermost panel 39a reaches the top of the track 31a. As the cable 22a continues to be pulled, the attachment point 24a reaches the deflection pulley 46. The lowermost runner 42 remains in the track 31. The deflection pulley 46 is sufficiently close to the track 31 to allow the attachment point 24a to pass outside the deflection pulley 46. That is, the attachment point 24 passes the deflection pulley beyond the deflection pulley 46, as viewed from the track 31. This passage of the attachment point 24a outside the deflection pulley 46 is illustrated in an exaggerated manner in FIGS. 13 and 14 by arrows 44. Consequently, when the door 12a is opening, the passage of the attachment point 24a unthreads the cable 22a from around the deflection pulley 46. The direction of pull on the attachment point 24a is now defined by the relative positions of the attachment point 24a and deflection pulley 48, as can be seen from FIG. 15. The pulley 48 is close to the track 31, near the horizontal section 31b. Accordingly, the door 12a can be pulled further open. Eventually, the attachment point 24a reaches the deflection pulley 48. The cable 22a then unthreads from around the deflection pulley 48, in similar manner to that described above. That is, the lowermost runner 42 remains in the track 31. The deflection pulley 48 is sufficiently close to the track 31 to allow the attachment point 24a to pass outside the deflection pulley 48. That is, the attachment point 24 passes the deflection pulley 48 beyond the deflection pulley 48, as viewed from the track 31 and the cable 22a unthreads from the deflection pulley 48.

It can be seen from FIG. 16 that once the cable 22a has unthread from the deflection pulley 48, the attachment point 24a can be pulled further around the transition section 31c and into the horizontal leg 31b of the track 31. This leaves the panels 39 all lying substantially horizontally along the horizontal leg 31b of the track 31. The whole of the door 12a can then be pulled back along the horizontal leg 31b, as far as the leg 31b will allow. The fully open door 12a has a depth z which is less than the depths x or y of the previous arrangements, as can be seen by a comparison of FIGS. 3, 10 and 16.

When the door is to be closed, the cable drum 26 is turned in the opposite direction to pay out cable 22a, allowing the door panels 39 to move back down the track 31 to the fully closed position. Again, a spring may be used to assist the movement. As the attachment point 24a reaches the deflection pulleys 46, 48, the attachment point 24a passes the pulleys 46, 48 beyond the pulleys 46, 48, as viewed from the track 31, so that the cable 22a is threaded back onto the deflection pulleys 46, 48.

Accordingly, it is envisaged that the arrangements described above in relation to FIGS. 4 to 16 can be installed within an aperture in which headroom is limited, so that the reduced depth achieved by the arrangement described results in an aperture which is less obstructed when the door is fully open. This reduced obstruction is further enhanced by the ability of the second example (FIGS. 12 to 16) to be withdrawn indefinitely along the horizontal leg of the track (subject to the limits of the horizontal leg).

Many variations and modifications can be made to the apparatus described above, without departing from the scope of the present invention. In the examples of FIGS. 4 to 11 and FIGS. 12 to 16, the cable drum 26a is positioned at the far end of the horizontal leg 31b of the track 31. Many other arrangements are possible. For example, the cable drum may be located at an alternative position, with additional guide members being provided to define an appropriate path for the cable, so that the cable can control the door in the manner described. One example of this is illustrated in FIGS. 17 and 18, using the same reference numerals as FIGS. 12 to 16. A pulley 50 is provided as an additional guide member near the far end of the horizontal leg 31b. The cable drum 26a is positioned at the front of the horizontal leg 31b, generally above the vertical leg 31a. The pulley 50 allows the cable to pull in a direction along the horizontal leg 31b. The guide members 46, 48 allow the cable 22a to pull in a direction up the vertical leg 31a, before the cable 22a unthreads. The result allows the door to be pulled open from a fully closed position (FIG. 17) to a fully open position (FIG. 18) in which the door is pulled fully back onto the horizontal leg 31b. This provision of additional guide members will allow the cable drum 26a to be positioned in a very wide range of positions (in various different installation conditions, for example) without changing the principles of operation of the apparatus, as described above. Placing a guide member at a position part way along or near the horizontal leg 31b will cause the cable to pull generally horizontally, along the horizontal leg 31b, even if the cable drum 26a is located elsewhere.

The elongate flexible member 22a has been described as a cable but could be an alternative, such as a chain, rope, cord or other member. The guide members 30, 32, 46, 48 have been described and illustrated as pulleys, but could be alternatives, such as ball races, chain sprockets, low friction surfaces or other structures. The drive arrangement described in the illustrated examples as a cable drum may take many different forms and may include a counterbalance shaft driven by a shaft mounted motor, or may be driven by a motor located elsewhere and suitably connected to the cable drum. In any of the examples, the operation may be assisted by a spring which is compressed as the door reaches the fully open position, to provide an open limit and also to push back when the cable is released, to start the movement of the door. Once some of the door has moved around the transition section 31c onto the vertical leg 31a, gravity will then ensure further movement towards the closed position, as the cable is released. Many different sizes, relative sizes, shapes and relative shapes could be devised for the various components illustrated in the accompanying drawings.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Apparatus comprising:
an aperture closure formed from a plurality of panels hinged together at generally horizontal axes;
at least one runner member attached to a vertical edge of the door;
a track defining the path of the or each runner member as the aperture closure opens and closes;
an elongate flexible member connected to the door at an attachment point and to a drive arrangement to allow the drive arrangement to pull the door open;
and at least one guide member to define the path of the elongate flexible member between the attachment point and the drive arrangement and which is a deflection member sufficiently close to the track to allow the attachment point to pass the or each deflection member beyond the deflection member when viewed from the said path, as the door closes and opens, thereby threading and unthreading the elongate flexible member from the or each deflection member.

2. Apparatus according to claim 1, wherein there is a plurality of guide members, at least some of which are deflection members from which the elongate flexible member threads and unthreads as aforesaid.

3. Apparatus according to claim 1, wherein all of the guide members are deflection members as aforesaid.

4. Apparatus according to claim 1, wherein the guide member or members are pulleys.

5. Apparatus according to claim 1, wherein the or one of the deflection members is the guide member closest to the attachment point, when the door is fully closed.

6. Apparatus according to claim 1, wherein there is a guide member which acts as a limit member and is spaced sufficiently from the track to prevent the attachment point passing to the other side of the limit member than the track, thereby providing an open limit of movement for the aperture closure.

7. Apparatus according to claim 1, wherein the track comprises a generally upright section and a further section for receiving the door, when open.

8. Apparatus according to claim 7, wherein the further section is generally horizontal.

9. Apparatus according to claim 7, wherein a transition section is provided, defining a curved leg of the path, between the upright section and the further section.

10. Apparatus according to claim 7, wherein the or one of the deflection members is located above the upright section.

11. Apparatus according to claim 9, wherein there are a plurality of deflection members positioned to guide the elongate flexible member around the transition section and from which the elongate flexible member is able to unthread as the door opens, to allow the door to move wholly on to the further section.

12. Apparatus according to claim 7, wherein the attachment point reaches a limit member after leaving the upright section.

13. Apparatus according to claim 7, wherein at least one guide member is associated with the further section to cause the elongate flexible member to pull along the further section, during use.

14. Apparatus according to claim 1, wherein the track is located alongside the edge of the door.

15. Apparatus according to claim 1, wherein tracks are provided alongside both edges of the door.
